(19) United States
(12) Patent Application Publication
(10) Pub. No.: US 2019/0387519 A1
(43) Pub. Date: Dec. 19, 2019

(54) METHOD AND DEVICE FOR INDICATING RESOURCE ALLOCATION

(71) Applicant: NEC CORPORATION, Tokyo (JP)

(72) Inventors: Gang WANG, Beijing (CN); Zhaobang MIAO, Beijing (CN)

(73) Assignee: NEC CORPORATION, Tokyo (JP)

(21) Appl. No.: 16/480,466

(22) PCT Filed: Jan. 25, 2017
(86) PCT No.: PCT/CN2017/072643

§ 371 Date: Jul. 24, 2019

(51) Int. Cl. H04W 72/04; H04L 5/00

(52) U.S. Cl. CPC H04W 72/048; H04L 5/0076; H04W 72/0473; H04L 5/0039; H04W 72/042; H04L 5/0094

(57) ABSTRACT

Embodiments of the disclosure provide a method and device for indicating resource allocation. The method comprises: determining information about one or more resource blocks allocated to a terminal device, the information indicating whether a resource block is a fractional resource block or a normal resource block, the fractional resource block including a guard band for separating transmissions on adjacent resource blocks; and transmitting the information about the allocated resource blocks to the terminal device.

### FIELD OF THE INVENTION

Embodiments of the present disclosure generally relate to communication techniques. More particularly, embodiments of the present disclosure relate to a method and device for indicating resource allocation.

### BACKGROUND OF THE INVENTION

Conventionally, resource allocation types define schemes to be employed in resource allocation. For example, Long Term Evolution (LTE) introduces Resource Allocation Types 0, 1, and 2, and details of them may be found in TS 36.213 7.1.6 resource allocation. In practice, a resource allocation field in Downlink Control Information (DCI) indicates the resource allocation type, and thus a terminal device may know the time-frequency resource allocated by a network device based on the resource allocation field. In the conventional solution, a basic unit of the allocated resource is a resource block, which contains 12 subcarriers for example.

Newly-developed mobile standards, for example, a New Radio (NR) system, support mixed numerologies on a single carrier. However, the mixed numerologies solution introduces interference on boundaries of resource blocks employing different numerologies. Therefore, transmissions on these resource blocks may interfere with each other, which reduces throughput of the communication system and degrade the system performance.

Accordingly, there is a need to develop a scheme for allocating resources to reduce interference on boundaries of resource blocks employing different numerologies.

### SUMMARY OF THE INVENTION

The present disclosure proposes a solution for reducing interference on boundaries of resource blocks employing different numerologies.

According to a first aspect of embodiments of the present disclosure, embodiments of the present disclosure provide a method performed by a network device. The network device determines information about one or more resource blocks allocated to a terminal device. The information indicates whether a resource block is a fractional resource block or a normal resource block. The fractional resource block includes a guard band for separating transmissions on adjacent resource blocks. Then, the network device transmits the information about the allocated resource blocks to the terminal device.

According to a second aspect of embodiments of the present disclosure, embodiments of the present disclosure provide method performed by a terminal device. The terminal device receives information about one or more resource blocks allocated to the terminal device from a network device. The information indicates whether a resource block is a fractional resource block or a normal resource block. The fractional resource block includes a guard band for separating transmissions on adjacent resource blocks. Then, the terminal device performs transmission with the network device based on the information about the one or more resource blocks.

According to a third aspect of embodiments of the present disclosure, embodiments of the disclosure provide a network device. The network device comprises: a controller configured to determine information about one or more resource blocks allocated to a terminal device, the information indicating whether a resource block is a fractional resource block or a normal resource block, the fractional resource block including a guard band for separating transmissions on adjacent resource blocks; and a transmitter configured to transmit the information about the allocated resource blocks to the terminal device.

According to a fourth aspect of embodiments of the present disclosure, embodiments of the disclosure provide a terminal device. The terminal device comprises: a receiver configured to receive information about one or more resource blocks allocated to the terminal device from a network device, the information indicating whether a resource block is a fractional resource block or a normal resource block, the fractional resource block including a guard band for separating transmissions on adjacent resource blocks; and a transmitter configured to perform transmission with the network device based on the information about the one or more resource blocks.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates a schematic diagram of a communication system 100 according to embodiments of the present disclosure;

FIGS. 2-4 illustrate diagrams of conventional resource allocation types;

FIG. 5 illustrates a flow chart of a method for resource allocation according to embodiments of the present disclosure;

FIGS. 6A-6C illustrate diagrams of a normal resource block and fractional resource blocks according to embodiments of the present disclosure;

FIGS. 7A-7D illustrate diagrams of a normal group of resource blocks and fractional groups of resource blocks according to embodiments of the present disclosure;

FIG. 8A illustrates a diagram of resource blocks according to embodiments of the present disclosure;

FIG. 8B illustrates a diagram of bitmaps for indicating resource blocks according to embodiments of the present disclosure;

FIG. 8C illustrates a diagram of bitmaps for indicating resource blocks according to further embodiments of the present disclosure;

FIG. 9 illustrates a flow chart of a method for resource allocation according to embodiments of the present disclosure;

FIG. 10 illustrates a schematic diagram of a network device according to an embodiment of the present disclosure; and

FIG. 11 illustrates a schematic diagram of a terminal device according to an embodiment of the present disclosure.

Throughout the figures, same or similar reference numbers indicate same or similar elements.

### DETAILED DESCRIPTION OF EMBODIMENTS

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/acts involved.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The term “network device” includes, but not limited to, a base station (BS), a gateway, a management entity, and other suitable device in a communication system. The term “base station” or “BS” represents a node B (NodeB or NB), an evolved NodeB (eNodeB or eNB), a Remote Radio Unit (RRU), a radio header (RH), a remote radio head (RRH), a relay, a low power node such as a femto, a pico, and so forth.

The term “terminal device” includes, but not limited to, “user equipment (UE)” and other suitable end device capable of communicating with the network device. By way of example, the “terminal device” may refer to a terminal, a Mobile Terminal (MT), a Subscriber Station (SS), a Portable Subscriber Station, a Mobile Station (MS), or an Access Terminal (AT).

In the context of the present disclosure, the term “numerology” refers to a set of parameters. In an Orthogonal Frequency Division Multiplexing (OFDM)-based system, the parameters include, for example, but not limited to, a subcarrier spacing, a symbol length, a length of a cyclic prefix (CP), and so on. For instance, a numerology for a subcarrier spacing of 15 KHz may include 14 symbols in one millisecond, a normal CP, and so on. A numerology for a subcarrier spacing of 30 KHz may include 28 symbols in one millisecond, a normal CP, and so on. Such a numerology is different from the numerology for the subcarrier spacing of 15 KHz.

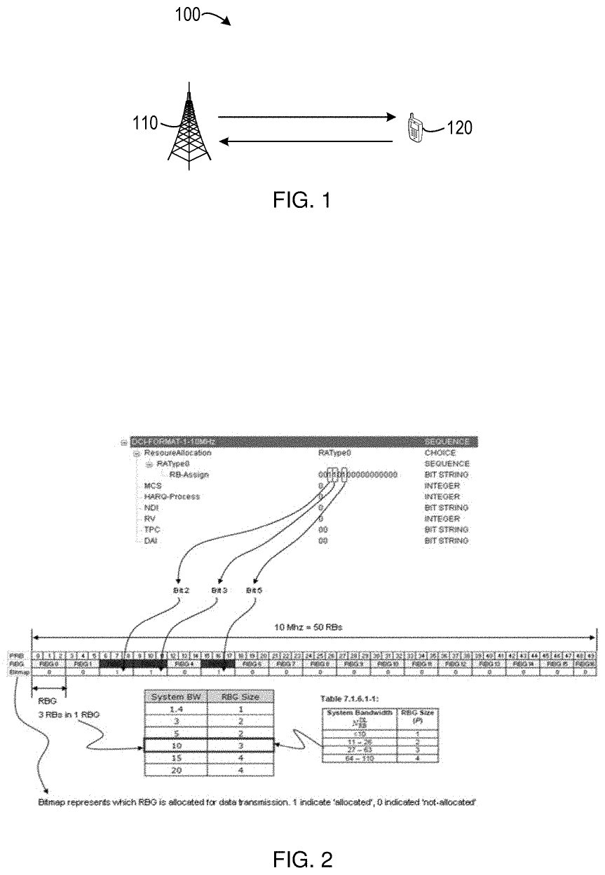

Now some exemplary embodiments of the present disclosure will be described below with reference to the figures. Reference is first made to FIG. 1, which illustrates schematic diagram of a communication system 100 according to embodiments of the present disclosure.

In the communication system 100, there illustrate a network device (for example, an eNB) 110 that communicates with a terminal device (for example, a UE) 120. The network device 110 allocates one or more resource blocks to the terminal device 120, and transmits information about the allocated resource blocks to the terminal device 120. The terminal device 120 receives information about the allocated resource blocks from the network device 110, and performs uplink transmission to the network device 110 based on the received information.

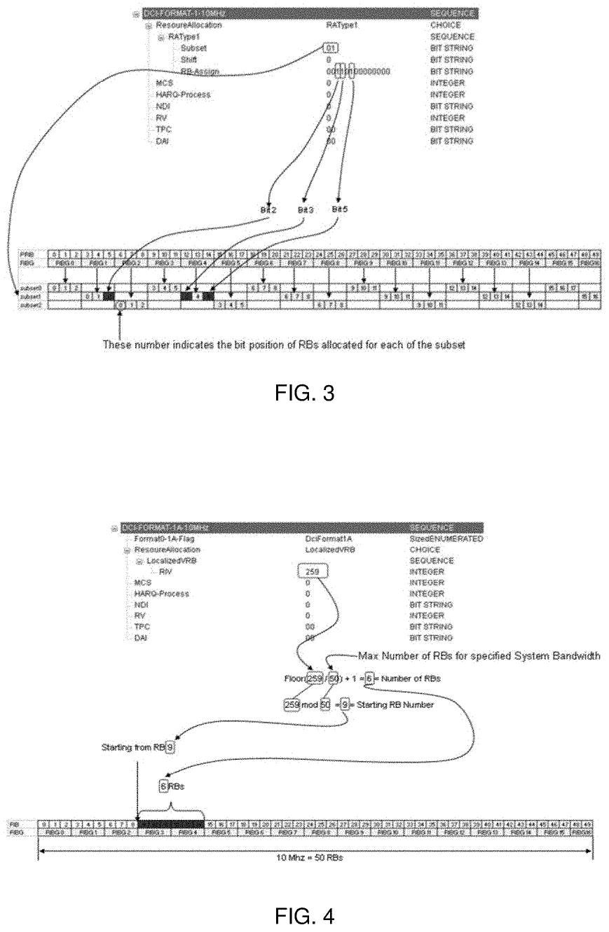

Now some exemplary embodiments of the present disclosure will be described below with reference to the following figures. As discussed above, LTE introduces Resource Allocation Types 0, 1, and 2. FIGS. 2, 3 and 4 illustrate diagrams of the Resource Allocation Types 0, 1, and 2, respectively. As shown in these three figures, all the three types employ a resource block (also referred to as “RB”) as the basic unit for allocating the time-frequency resource. However, the conventional resource allocation schemes cannot solve the problem of interference on boundaries of resource blocks caused by mixed numerologies. Thus, throughput of the communication system is reduced and performance of the communication system is degraded.

In order to solve the above and other potential problems, embodiments of the present disclosure provide solutions for reducing interference on boundaries of resource blocks. In accordance with embodiments of the present disclosure, the type of a resource block may be a normal type or a fractional type. Accordingly, there are two types of resource blocks, a normal resource block and a fractional resource block. The fractional resource block includes a guard band for separating transmissions on adjacent resource blocks. According to embodiments of the present disclosure, the network device 110 determines information about one or more resource blocks allocated to a terminal device. The information indicates whether a resource block is a fractional resource block or a normal resource block. Then, the network device 110 transmits the information about the allocated resource blocks to the terminal device 120. Upon receipt of the information about the resource blocks, the terminal device 120 knows the types of the allocated resource blocks and performs transmission with the network device 110 on the allocated resource blocks. In this way, the granularity of resource allocation can be reduced to less than a resource block. As such, interference on boundaries of resource blocks caused by mixed numerologies may be reduced by arranging the fractional resource block at the boundaries. As a result, throughput of the communication system is increased and performance of the communication system is improved.

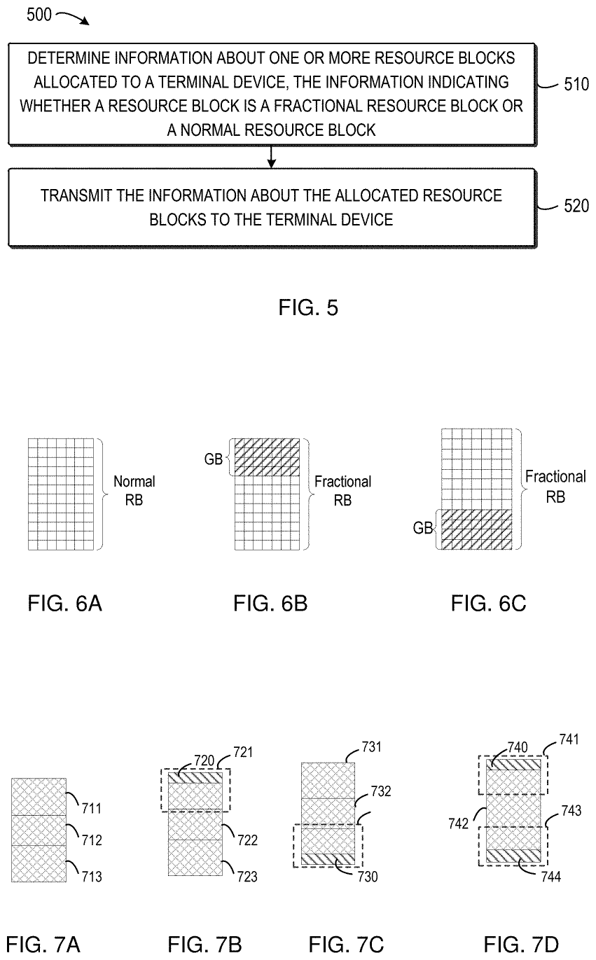

FIG. 5 illustrates a flow chart of a method 500 for resource allocation according to embodiments of the present disclosure. The method 500 may be implemented by the network device 110, for example, an eNB or other suitable device.

The method 500 is entered at 510, where the network device 110 determines information about one or more resource blocks allocated to a terminal device. The information indicates whether a resource block is a fractional resource block or a normal resource block. The fractional resource block includes a guard band for separating transmissions on adjacent resource blocks. The normal resource block does not include any guard band and is similar to the conventional resource block.

The information about the allocated resource blocks may be determined in several ways. In some embodiments, the network device 110 may determine whether a resource block of the allocated resource blocks is a fractional resource block or a normal resource block. In response to determining that the resource block is a fractional resource block, the network device 110 determines a position and a size of the guard band in the resource block.

FIGS. 6A-6C illustrate diagrams of a normal resource block and fractional resource blocks according to embodiments of the present disclosure. Specifically, FIG. 6A shows an example of a normal resource block. In this example, one bit may be used to indicate the type of the resource block is a normal RB. For instance, the bit “0” may indicate that this resource block is a normal RB, and the bit “1” may indicate that this resource block is a fractional RB.

FIG. 6B shows an example of a fractional RB which has a guard band (also referred to as “GB”) on the top of the resource block. FIG. 6C shows an example of a fractional RB which has a GB at the bottom of the resource block. In these examples, an additional bit “0” or “1” is employed to indicate the position of the guard band in a fractional RB. For example, “0” may indicate that the GB exists on the top (higher frequency) of the fractional RB, and “1” may indicate the GB exists at the bottom (lower frequency) of the fractional RB. Other part of the fractional RB than the GB may be used to perform transmission with the network device 110.

Further additional bit(s) may be employed to indicate the size of the GB in the fractional RB. The size may indicate how many subcarriers are used as the GB. With the information of the size and the position of the GB, the fractional RB can be clearly indicated.

In some embodiments, the bits used for indicating the fractional RB may constitute a bitmap, and the size of the bitmap may be determined by a granularity of the GB. For example, if the granularity of the GB is one subcarrier, the GB size has 12 values for a resource block including 12 subcarriers. In this case, 4 bits (2\hat{ }4=16>12) may be used to indicate the 12 values. In another example, if the granularity of the GB is two subcarriers, the GB size has 6 values for a resource block including 12 subcarriers. In this case, 3 bits (2\hat{ }3=8>6) may be used to indicate the 6 values.

Alternatively, in some embodiments, the network device 110 may select a group of contiguous resource blocks from the allocated resource blocks, and then determines information about the group of contiguous resource blocks. The group of contiguous resource blocks may be a plurality of RBs that are contiguous and are not adjacent to any other allocated resource blocks. In the determination of the information about the group of contiguous resource blocks, the network device 110 may determine whether a resource block in the group is a fractional resource block or a normal resource block. If the resource block is a fractional resource block, the network device 110 may determine a position and a size of the guard band in the resource block. If the resource block is a normal resource block, the network device 110 may determine an indication indicating the normal resource block. In this way, the factional RB may be indicated in a more efficient way.

FIGS. 7A-7D illustrate diagrams of a normal group of resource blocks and fractional groups of resource blocks according to embodiments of the present disclosure, respectively. In the examples of FIGS. 7A-7D, contiguous RBs allocated to a same terminal device is considered as a whole. The fractional RB may be indicated by a few bits, for example, in the form of a bitmap, that indicate the position and size of the GB on the boundary.

FIG. 7A shows a normal group of RBs, that is, a group of contiguous normal resource blocks 711, 712 and 713. In this example, the group of contiguous normal RBs may be indicated by bits “00”, which means that all the RBs in the group are normal RBs without any GB. In this case, no additional bits may be needed.

FIG. 7B shows a group of contiguous resource blocks including a fractional RB 721 and two normal RBs 722 and 723. The fractional RB 721 includes a GB 720 on the top. In this case, bits “10” may be used to indicate the position of the GB. Additional 4 bits (or fewer than 4 bits) may be used to indicate the size of the GB.

FIG. 7C shows a group of contiguous resource blocks including a fractional RB 733 and two normal RBs 731 and 732. The fractional RB 733 includes a GB 730 at the bottom. In this case, bits “01” may be used to indicate the position of the GB. Additional 4 bits (or fewer than 4 bits) may be used to indicate the size of the GB.

FIG. 7D shows a group of contiguous resource blocks including two fractional RBs 741 and 743 as well as a normal RB 742. The fractional RB 741 includes a GB 740 on the top and the fractional RB 743 includes a GB 744 at the bottom. In this case, bits “11” may be used to indicate the positions of the GBs. Additional 8 bits (or fewer than 8 bits) may be used to indicate the size of the GBs.

Still referring to FIG. 5, at 520, the network device 110 transmits the information about the allocated resource blocks to the terminal device 120. The information about the allocated resource blocks may be transmitted directly to the terminal device 120. Alternatively, the network device 110 may convert the information about the allocated resource blocks to a bitmap. Then, the network device 110 may transmit the bitmap to the terminal device 120.

The bitmap may have a size associated with a granularity of the guard band. With the bitmap, the type of the resource blocks may be indicated after resource allocation. In addition, the bitmap may also indicate the position and size of guard band for each fractional RB.

In some embodiment, each RB may have a bitmap. Alternatively, a group of contiguous RBs may have a bitmap. It is to be understood that these are examples, rather than limitations. The type of the RBs may be indicated in other suitable ways.

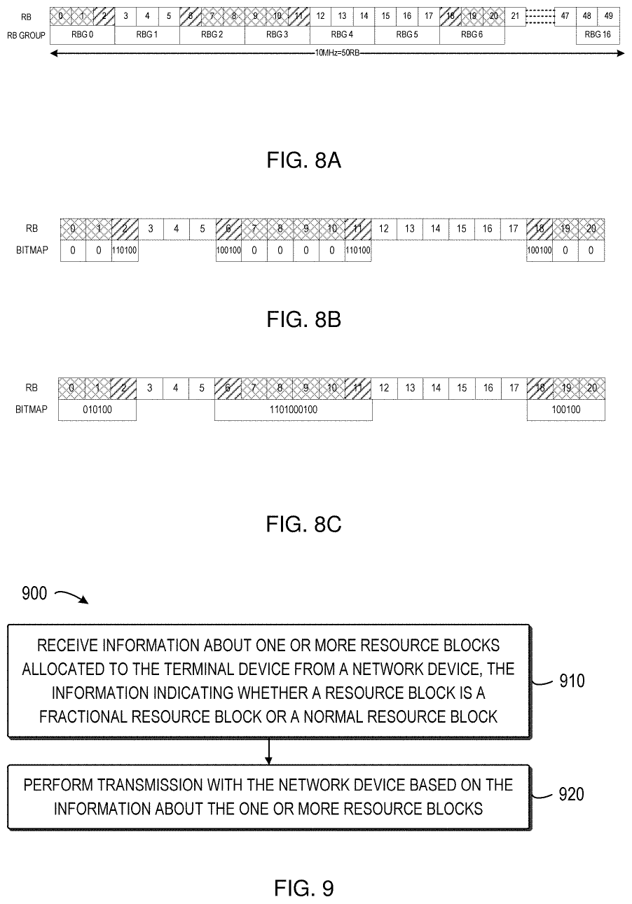

Now more embodiments of the present disclosure will be described below with reference to FIGS. 8A-8C. FIG. 8A illustrates a diagram of resource blocks according to embodiments of the present disclosure. In the examples of FIG. 8A-8C, assuming that RBs 0-2, 6-11 and 18-20 are allocated to the terminal device 120, and assuming that RBs 2, 6,11 and 18 are fractional RBs, RBs 0, 1, 7, 8, 9, 10, 19 and 20 are normal RBs. As shown in FIG. 8A, each of RGB 0 to RGB 6 comprises three RBs. The size of the guard band, namely the GB size is assumed to be 4 subcarriers.

FIG. 8B illustrates a diagram of bitmaps for indicating resource blocks according to embodiments of the present disclosure. In the example of FIG. 8B, since RBs 0, 1, 7, 8, 9, 10, 19 and 20 are normal RBs, the bitmap for each of them may be “0”. The fractional RB 2 may be indicated by the bitmap “110100”, in which the first bit “1” indicates that RB 2 is a fractional RB, the second bit “1” indicates that a GB is at the bottom of RB 2 (in this example, the right of RB 2), and the last four bits “0100” indicates that there are four subcarriers in the GB. RB 11 may be indicated by the same bitmap “110100” in this example, and details are thus omitted.

Regarding RB 6, it may be indicated by a bitmap “100100”. In this bitmap, the first bit “1” indicates that RB 6 is a fractional RB, the second bit “0” indicates that a GB is on the top of RB 6 (in this example, the left of RB 6), and the last four bits “0100” indicates that there are four subcarriers in the GB. RB 18 may be indicated by the same bitmap “100100” in this example, and details are thus omitted.

FIG. 8C illustrates a diagram of bitmaps for indicating resource blocks according to further embodiments of the present disclosure. In the example of FIG. 8C, a group of contiguous resource blocks are indicated by a bitmap. For example, for a first group of RB that including RBs 0-2, the bitmap may be “010100”. The first two bits “01” indicate that the position of the GB is at the bottom of the RBs in the first group, and the last four bits “0100” indicate that that there are four subcarriers in the GB.

For a second group of RB that including RBs 6-11, the bitmap may be “1101000100”. The first two bits “11” indicate that the positions of the GBs is both at the bottom and on the top of the RBs in the second group, that is, the GBs are located in both RBs 6 and 11. The next four bits “0100” indicate that that there are four subcarriers in the GB of RB 6. The last four bits “0100” indicate that that there are four subcarriers in the GB of RB 11.

For a third group of RB that including RBs 18-20, the bitmap may be “100100”. The first two bits “10” indicate that the position of the GB is on the top of the RBs in the first group, that is, located on the top of RB 18. The last four bits “0100” indicate that that there are four subcarriers in the GB.

FIG. 9 illustrates a flow chart of a method 900 for resource allocation according to embodiments of the present disclosure. The method 900 may be implemented by the terminal device 120, for example, a UE or other suitable device.

The method 900 is entered at 910, where the terminal device 120 receives information about one or more resource blocks allocated to the terminal device from a network device. The information indicates whether a resource block is a fractional resource block or a normal resource block. The fractional resource block includes a guard band for separating transmissions on adjacent resource blocks.

In some embodiments, the terminal device 120 may determine, from the received information, whether a resource block of the allocated resource blocks is a fractional resource block or a normal resource block. If the terminal device 120 determines that the resource block is a fractional resource block, it may determine a position and a size of the guard band in the resource block from the received information.

Alternatively, in some embodiments, the terminal device 120 may determine information about a group of contiguous resource blocks from the received information. The group of contiguous resource blocks may be selected from the allocated resource blocks. In the determination of the information about a group of contiguous resource blocks, the terminal device 120 may determine whether a resource block in the group is a fractional resource block or a normal resource block. If the resource block is a fractional resource block, the terminal device 120 may determine a position and a size of the guard band in the resource block. If the resource block is a normal resource block, the terminal device 120 may determine an indication indicating the normal resource block.

Additionally, in some embodiments, the terminal device 120 may receive, from the network device 110, a bitmap indicating the information about the allocated resource blocks. The bitmap may have a size associated with a granularity of the guard band.

At 920, the terminal device 120 performs transmission with the network device based on the information about the one or more resource blocks.

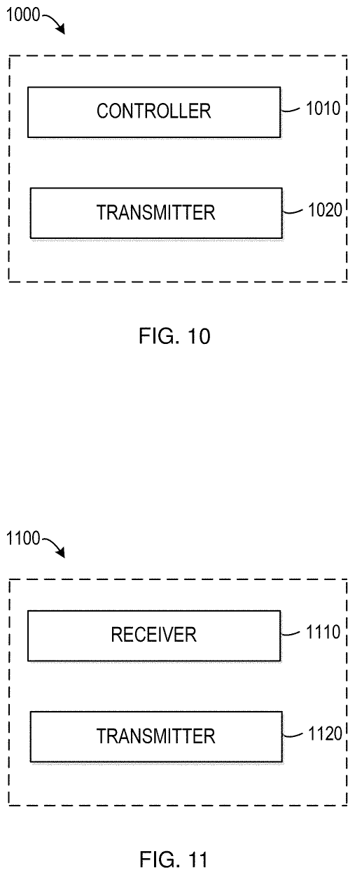

FIG. 10 illustrates a schematic diagram of a network device 1000 according to an embodiment of the present disclosure. According to embodiments of the present disclosure, the network device 1000 may be implemented as the network device 110 or other suitable device in the communication system.

As shown in FIG. 10, the network device 1000 comprises: a controller 1010 configured to determine information about one or more resource blocks allocated to a terminal device, the information indicating whether a resource block is a fractional resource block or a normal resource block, the fractional resource block including a guard band for separating transmissions on adjacent resource blocks; and a transmitter 1020 configured to transmit the information about the allocated resource blocks to the terminal device.

In some embodiments, the controller 1010 may be further configured to: determine whether a resource block of the allocated resource blocks is a fractional resource block or a normal resource block; and in response to determining that the resource block is a fractional resource block, determine a position and a size of the guard band in the resource block.

In some embodiments, the controller 1010 may be further configured to: select a group of contiguous resource blocks from the allocated resource blocks; and determine information about the group of contiguous resource blocks.

In some embodiments, the controller 1010 may be further configured to: determine whether a resource block in the group is a fractional resource block or a normal resource block; in response to determining that the resource block is a fractional resource block, determine a position and a size of the guard band in the resource block; and in response to determining that the resource block is a normal resource block, determine an indication indicating the normal resource block.

In some embodiments, the controller 1010 may be further configured to: convert the information about the allocated resource blocks to a bitmap, the bitmap having a size associated with a granularity of the guard band, and wherein the transmitter 1020 may be further configured to transmit the bitmap to the terminal device.

FIG. 11 illustrates a schematic diagram of a terminal device 1100 according to an embodiment of the present disclosure. According to embodiments of the present disclosure, the terminal device 1100 may be implemented as the terminal device 120 or other suitable device in the communication system.

As shown in FIG. 11, the terminal device 1100 comprises: a receiver 1110 configured to receive information about one or more resource blocks allocated to the terminal device from a network device, the information indicating whether a resource block is a fractional resource block or a normal resource block, the fractional resource block including a guard band for separating transmissions on adjacent resource blocks; and a transmitter 1120 configured to perform transmission with the network device based on the information about the one or more resource blocks.

In some embodiments, the terminal device 1100 may further comprise a controller configured to: determine, from the received information, whether a resource block of the allocated resource blocks is a fractional resource block or a normal resource block; and in response to determining that the resource block is a fractional resource block, determine a position and a size of the guard band in the resource block from the received information.

In some embodiments, the terminal device 1100 may further comprise a controller configured to: determine information about a group of contiguous resource blocks from the received information, the group of contiguous resource blocks being selected from the allocated resource blocks.

In some embodiments, the controller may be further configured to: determine whether a resource block in the group is a fractional resource block or a normal resource block; in response to determining that the resource block is a fractional resource block, determine a position and a size of the guard band in the resource block; and in response to determining that the resource block is a normal resource block, determine an indication indicating the normal resource block.

In some embodiments, the receiver 1110 may be further configured to: receive, from the network device, a bitmap indicating the information about the allocated resource blocks, the bitmap having a size associated with a granularity of the guard band.

It is also to be noted that the device 1000 or 1100 may be respectively implemented by any suitable technique either known at present or developed in the future. Further, a single device shown in FIG. 10 or 11 may be alternatively implemented in multiple devices separately, and multiple separated devices may be implemented in a single device. The scope of the present disclosure is not limited in these regards.

It is noted that the device 1000 or 1100 may be configured to implement functionalities as described with reference to FIG. 5 or FIG. 9. Therefore, the features discussed with respect to the method 500 may apply to the corresponding components of the device 1000, and the features discussed with respect to the method 900 may apply to the corresponding components of the device 1100. It is further noted that the components of the device 1000 or 1100 may be embodied in hardware, software, firmware, and/or any combination thereof. For example, the components of the device 1000 or 1100 may be respectively implemented by a circuit, a processor or any other appropriate device. Those skilled in the art will appreciate that the aforesaid examples are only for illustration not limitation.

In some embodiment of the present disclosure, the device 1000 or 1100 may comprise at least one processor. The at least one processor suitable for use with embodiments of the present disclosure may include, by way of example, both general and special purpose processors already known or developed in the future. The device 1000 or 1100 may further comprise at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the device 1000 to at least perform according to the method 500 as discussed above and to cause the device 1100 to at least perform according to the method 900 as discussed above.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIG. 5 or 9 may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purpose of limitation.

What is claimed is:

1. A method performed by a network device, comprising:
determining information about one or more resource blocks allocated to a terminal device, the information indicating whether a resource block is a fractional resource block or a normal resource block, the fractional resource block including a guard band for separating transmissions on adjacent resource blocks; and
transmitting the information about the allocated resource blocks to the terminal device.

2. The method according to claim 1, wherein determining information about one or more resource blocks comprises:
determining whether a resource block of the allocated resource blocks is a fractional resource block or a normal resource block; and
in response to determining that the resource block is a fractional resource block, determining a position and a size of the guard band in the resource block.

3. The method according to claim 1, wherein determining information about one or more resource blocks comprises:
selecting a group of contiguous resource blocks from the allocated resource blocks; and
determining information about the group of contiguous resource blocks.

4. The method according to claim 3, wherein determining information about the group of contiguous resource blocks comprises:
determining whether a resource block in the group is a fractional resource block or a normal resource block;
in response to determining that the resource block is a fractional resource block, determining a position and a size of the guard band in the resource block; and
in response to determining that the resource block is a normal resource block, determining an indication indicating the normal resource block.

5. The method according to claim 1, further comprising:
converting the information about the allocated resource blocks to a bitmap, the bitmap having a size associated with a granularity of the guard band, and
wherein transmitting the information about the allocated resource blocks to the terminal device comprises:
transmitting the bitmap to the terminal device.

6. A method performed by a terminal device, comprising:
receiving information about one or more resource blocks allocated to the terminal device from a network device, the information indicating whether a resource block is a fractional resource block or a normal resource block, the fractional resource block including a guard band for separating transmissions on adjacent resource blocks; and
performing transmission with the network device based on the information about the one or more resource blocks.

7. The method according to claim 6, wherein receiving information about one or more resource blocks allocated to the terminal device from a network device comprises:
determining, from the received information, whether a resource block of the allocated resource blocks is a fractional resource block or a normal resource block; and
in response to determining that the resource block is a fractional resource block, determining a position and a size of the guard band in the resource block from the received information.

8. The method according to claim 6, wherein receiving information about one or more resource blocks allocated to the terminal device from a network device comprises:
determining information about a group of contiguous resource blocks from the received information, the group of contiguous resource blocks being selected from the allocated resource blocks.

9. The method according to claim 8, wherein determining information about a group of contiguous resource blocks comprises:
determining whether a resource block in the group is a fractional resource block or a normal resource block;
in response to determining that the resource block is a fractional resource block, determining a position and a size of the guard band in the resource block; and
in response to determining that the resource block is a normal resource block, determining an indication indicating the normal resource block.

10. The method according to claim 6, wherein receiving information about one or more resource blocks allocated to the terminal device from a network device comprises:
receiving, from the network device, a bitmap indicating the information about the allocated resource blocks, the bitmap having a size associated with a granularity of the guard band.

11. A network device, comprising:
a controller configured to determine information about one or more resource blocks allocated to a terminal device, the information indicating whether a resource block is a fractional resource block or a normal resource block, the fractional resource block including a guard band for separating transmissions on adjacent resource blocks; and
a transmitter configured to transmit the information about the allocated resource blocks to the terminal device.

12. The network device according to claim 11, wherein the controller is further configured to:
determine whether a resource block of the allocated resource blocks is a fractional resource block or a normal resource block; and
in response to determining that the resource block is a fractional resource block, determine a position and a size of the guard band in the resource block.

13. The network device according to claim 11, wherein the controller is further configured to:
select a group of contiguous resource blocks from the allocated resource blocks; and
determine information about the group of contiguous resource blocks.

14. The network device according to claim 13, wherein the controller is further configured to:
determine whether a resource block in the group is a fractional resource block or a normal resource block;
in response to determining that the resource block is a fractional resource block, determine a position and a size of the guard band in the resource block; and
in response to determining that the resource block is a normal resource block, determine an indication indicating the normal resource block.

15. The network device according to claim 11, wherein the controller is further configured to: convert the information about the allocated resource blocks to a bitmap, the bitmap having a size associated with a granularity of the guard band, and
wherein the transmitter is further configured to: transmit the bitmap to the terminal device.

16. A terminal device, comprising:
a receiver configured to receive information about one or more resource blocks allocated to the terminal device from a network device, the information indicating whether a resource block is a fractional resource block or a normal resource block, the fractional resource block including a guard band for separating transmissions on adjacent resource blocks; and
a transmitter configured to perform transmission with the network device based on the information about the one or more resource blocks.

17. The terminal device according to claim 16, further comprising a controller configured to:
determine, from the received information, whether a resource block of the allocated resource blocks is a fractional resource block or a normal resource block; and
in response to determining that the resource block is a fractional resource block, determine a position and a size of the guard band in the resource block from the received information.

18. The terminal device according to claim 16, further comprising a controller configured to:
determine information about a group of contiguous resource blocks from the received information, the group of contiguous resource blocks being selected from the allocated resource blocks.

19. The terminal device according to claim 18, wherein the controller is further configured to:
determine whether a resource block in the group is a fractional resource block or a normal resource block;
in response to determining that the resource block is a fractional resource block, determine a position and a size of the guard band in the resource block; and
in response to determining that the resource block is a normal resource block, determine an indication indicating the normal resource block.

20. The terminal device according to claim 16, wherein the receiver is further configured to:
receive, from the network device, a bitmap indicating the information about the allocated resource blocks, the bitmap having a size associated with a granularity of the guard band.
